(19) United States
(12) Patent Application Publication
(10) Pub. No.: US 2014/0310016 A1
(43) Pub. Date: Oct. 16, 2014

(54) Medical Treatment Methods

(71) Applicant: Discus Analytics, LLC, Spokane, WA (US)

(72) Inventors: Howard M. Kenney, Spokane, WA (US); Jeffrey B. Butler, Spokane, WA (US); Gary L. Craig, Colbert, WA (US); Sean P. LaSalle, Spokane, WA (US); Eric C. Mueller, Spokane (WA); Karen M. Ferguson, Colbert, WA (US); Keith D. Knapp, Spokane, WA (US)

(73) Assignee: Discus Analytics, LLC, Spokane, WA (US)

(21) Appl. No.: 14/250,983

(22) Filed: Apr. 11, 2014

Related U.S. Application Data
(60) Provisional application No. 61/811,605, filed on Apr. 12, 2013.

(51) Int. Cl. G06Q 50/22

(52) U.S. Cl. CPC G06Q 50/22
USPC 705/2

(57) ABSTRACT

Medical treatment methods are described. According to one aspect, a medical treatment method includes obtaining data values for a plurality of patient characteristics of a subject patient to be treated for a medical condition, using the data values of the patient characteristics of the subject patient, searching treatment results of a plurality previous patients which were treated for the medical condition using a plurality of different treatment options, and using the searching, providing information to medical personnel regarding the treatment results of the previous patients which were treated for the medical condition for each of the treatment options, the information being usable to assist the medical personnel with treatment of the subject patient for the medical condition.

### RELATED PATENT DATA

This application claims priority to U.S. Provisional Patent Application Ser. No. 61/811,605, which was filed on Apr. 12, 2013, entitled “Methods and Apparatus for Processing Medical Data”, the disclosure of which is incorporated herein by reference.

### TECHNICAL FIELD

This disclosure relates to medical treatment methods.

### BACKGROUND OF THE DISCLOSURE

There are typically multiple options (e.g., different medications) to treat a patient for a medical condition or a disease. However, it may not be clear which option is the best to use for a given patient. Biological agents have been utilized for the treatment of medical conditions, such as rheumatoid arthritis and other autoimmune diseases (e.g. spondyloarthropathies). It is estimated that over 40% of patients with rheumatoid arthritis have been treated with at least one biological agent. These therapies are significantly more expensive than other available non-biological remittive medications, such as methotrexate used to treat rheumatoid arthritis or spondyloarthropathies.

Aspects of this disclosure are directed towards apparatus and methods to improve treatment of medical conditions of patients including assisting medical personnel with selection of appropriate treatment options.

### BRIEF DESCRIPTION OF THE DRAWINGS

Example embodiments of the disclosure are described below with reference to the following accompanying drawings.

FIG. 1 is a functional block diagram of a computing system according to one embodiment.

FIG. 2 is a functional block diagram of individual components of the computing system according to one embodiment.

FIG. 3 is illustrative representation of operations performed by the computing system according to one embodiment.

FIG. 4 is a flow chart of a method for treating a medical condition of a subject patient according to one embodiment.

FIG. 5 is a flow chart of determining predictor patient characteristics according to one embodiment.

FIG. 6 is a flow chart of determining populations of previous patients according to one embodiment.

FIG. 7 is a graphical representation of a screen display of treatment results of previous patients according to one embodiment.

FIG. 7a is a graphical representation of a screen display of treatment results of previous patients according to one embodiment.

FIG. 8 is a graphical user interface which may be utilized to assist medical personnel with treatment of medical patients according to one embodiment.

FIG. 9 is a flow chart of a method to compare the treatment options with respect to one another according to one embodiment.

FIG. 10 is a flow chart of a method to allocate points for low disease activity or remission for the treatment options according to one embodiment.

FIG. 11 is a flow chart of a method to allocate points for adverse events according to one embodiment.

### DETAILED DESCRIPTION OF THE DISCLOSURE

This disclosure is submitted in furtherance of the constitutional purposes of the U.S. Patent Laws “to promote the progress of science and useful arts” (Article 1, Section 8).

At least some aspects of the disclosure are directed towards methods and apparatus for assisting medical personnel with treatment of a medical condition of a subject patient. The embodiments disclosed herein are tailored to rheumatology and are merely examples to illustrate aspects of the present disclosure. However, the disclosed methods and apparatus may be utilized in other specialties of medicine in other implementations or embodiments. In more specific embodiments described below, the apparatus and methods may utilize a web-based, comparative research database containing information regarding numerous previous patients who have been previously treated for a common medical condition, such as rheumatoid arthritis or spondyloarthropathies.

Many treatment options may be available to treat some medical conditions, such as rheumatoid arthritis or spondyloarthropathies. For example, different medicines or combinations of medicines may be used to treat a medical condition. At least some of the disclosed methods and apparatus may be utilized to assist medical personnel with selecting an appropriate one of a plurality of treatment options to treat a medical condition of a subject patient.

In one embodiment described below, data values of patient characteristics of the subject patient with a medical condition are obtained and processed with respect to data values of previous patients who have been treated for the same medical condition to identify a population of the previous patients who are similar to the subject patient. Thereafter, the results of treatment of the previous patients for the different treatment options may be analyzed in an effort to provide information which may assist the medical personnel with selecting one of the treatment options to treat the medical condition of the subject patient. Additional aspects and embodiments of the disclosure are described below.

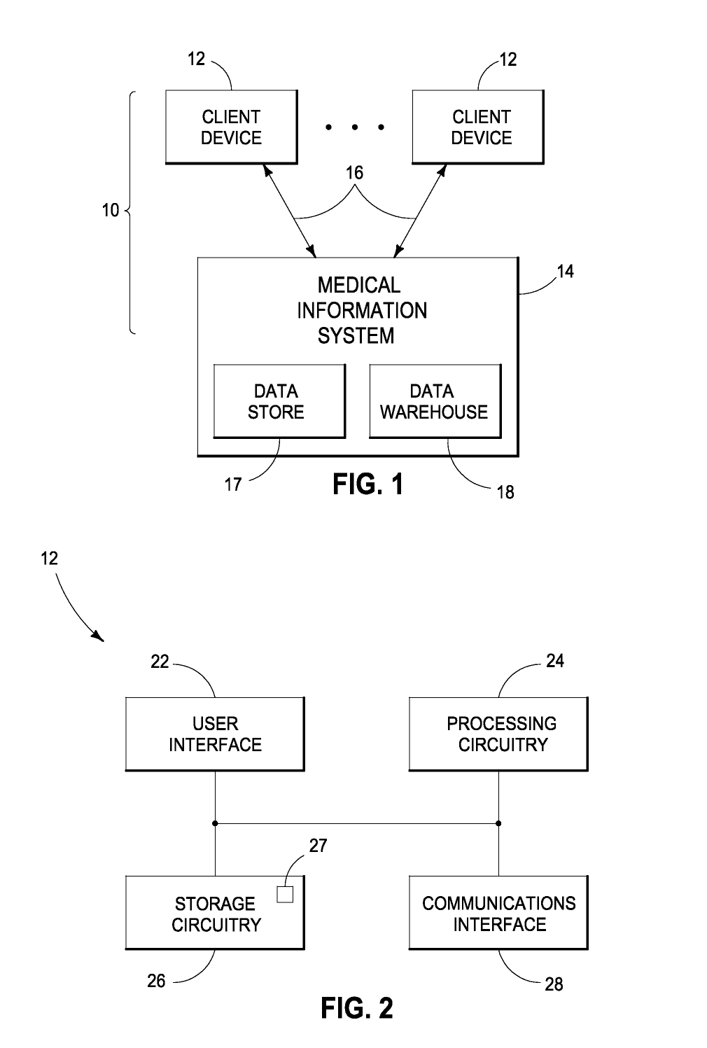

Referring to FIG. 1, a computing system 10 which is configured to implement some aspects of the disclosure is shown according to one example embodiment. The illustrated computing system 10 includes one or more client devices 12, a medical information system 14 and communications media 16 configured to implement communications intermediate client devices 12 and medical information system 14.

In one example, client devices 12 are implemented within different physician offices or clinics. Communications media 16 may be an appropriate network (e.g., the Internet, local or wide area networks, etc.) in one example implementation. Other configurations of computing system 10 are possible. For example, medical information system 14 may be omitted in some arrangements and aspects of the disclosure may be implemented using a client device 12.

Client devices 12 may be configured as personal or portable notebook computers in example implementations. Medical personnel (e.g., physicians, physician assistants, nurses, etc.) may communicate with patients during examinations and use the client devices 12 to input, generate and record information pertaining to the health of the patients. The inputted information may result from patient's answers to diagnosis questions and/or results of examinations and tests in some examples. In some embodiments, patients provide data for a plurality of patient characteristics. Example patient characteristics include information pertinent to the patient including age, medication history, diagnosis and diagnosis coding of any methodology, biomarkers, epigenetic profiles, genetic characteristics, exomes, transcriptomes and other genetic/genome marker, comorbidities and serum status. Additional patient characteristics may also be analyzed and are included below in Appendix A.

For example, data values of patient characteristics and disease activity metrics (also referred to as disease activity measures and which may include RAPID3, CDAI, SDAI, DAS28, DAS28-CRP, and Vectra DA in an illustrative example for a rheumatoid arthritis or a spondyloarthropathy medical condition) for the patient to be treated may be inputted into a computer and/or calculated during a patient encounter. Additional details regarding an example computer system and method for obtaining information from a patient are described in a U.S. Pat. No. 8,458,610, entitled “Medical Information Generation and Recordation Methods and Apparatus”, having Ser. No. 12/726,281, filed on Mar. 17, 2010, and the teachings of which are incorporated herein by reference.

Client devices 12 may communicate information obtained from patients (such as the data values for the patient characteristics and disease activity metrics) to medical information system 14 via communications media 16. This information regarding the health of the patients, also referred to as patient treatment data, may be provided into an electronic record corresponding to the patient and communicated to medical information system 14 for storage, for example within a database. The electronic records may be reviewed at later moments in time and supplemented with additional information as the patient is treated at different moments in time by the medical personnel. The patient treatment data communicated to the system 14 may also include any other information pertinent to the health and medical treatment of the patients, including for example, joint condition data, other medical conditions of the patients, diseases or ailments of the patients, results of the examinations, etc.

Medical information system 14 may include a database configured to store the electronic records including information regarding the patient's health for later retrieval and processing. In some embodiments described below, the patient treatment data may also be de-identified (e.g., all information which identifies the patients may be removed), and thereafter the aggregate patient treatment data from plural medical providers may be analyzed, including being subjected to statistical analysis and data mined, and the results of the processing may be utilized in various applications including assisting medical personnel with selecting one of a plurality of possible treatment options for treating a medical condition as described further below.

In one embodiment, system 14 associates the patient treatment data with respective patients, for example, using patient identification numbers and encounter identification numbers (corresponding to each encounter of the patient with a medical provider). The medical information system 14 includes a data store 17 and a data warehouse 18 to store electronic records and data of patients (e.g., values for different patient characteristics and disease activity metrics corresponding to the patients) and process the stored information in one embodiment. The data store 17 and data warehouse 18 exchange information with the client devices 12 and perhaps other entities (not shown).

Although not shown, data store 17 and data warehouse 18 of medical information system 14 may each include a web server, business logic unit and database. A web server of data store 17 may be configured to implement secure communications (e.g., via a VPN or the SSL protocol) with respect to client devices 14 and data warehouse 18. For example, patient treatment data regarding individual patients may be communicated to client devices 12 during treatment of the patients, for example using respective web pages for the respective patients served by the web server. Additional details regarding an example of this system and database are described in a U.S. patent application Ser. No. 13/606,880, filed Sep. 7, 2012, and entitled “Medical Information Systems and Medical Data Processing Methods,” the teachings of which are incorporated herein by reference.

The medical personnel may use the patient web pages to insert patient treatment data resulting from encounters with the patients. Furthermore, the patient web pages may also include templates to assist medical personnel with the entry of data resulting from a patient encounter and the entered data may be stored within the database of data store 17 in one embodiment. The data for the respective patients may be stored with the patient number and encounter number in the database of data store 17. In one embodiment, the data within database of data store 17 includes information which identifies the patient and may be used to back-up patient treatment data of the client devices 12.

Data warehouse 18 includes a database which stores an anonymous, de-identified version of the data from the data store 17. For example, data within the data store 17 may be provided to data warehouse 18 on a periodic basis (e.g., daily). Patient identification information (e.g., name, birthdate, etc.) may be de-identified (e.g., stripped) from the patient treatment data stored within database 17 during transfer to the data warehouse 18 providing anonymous data which still includes the patient treatment data for the patients on a patient basis but without an ability to directly identify the individual patients to which any of the anonymous data corresponds. For example, the data fields which contain patient identification data to be stripped are not copied to the database of the warehouse 18 during a copy procedure from data store 17 in one embodiment.

In one embodiment, a patient identifier number may remain associated with the data of a respective patient and which does not directly identify the patient for the respective data. In one embodiment, a business logic unit of data warehouse 18 may be utilized to perform processing of the anonymous patient treatment data as well as generating reports and results of the processing. Details of example processing are described below. Generated reports may be securely provided to client devices 12 or other entities.

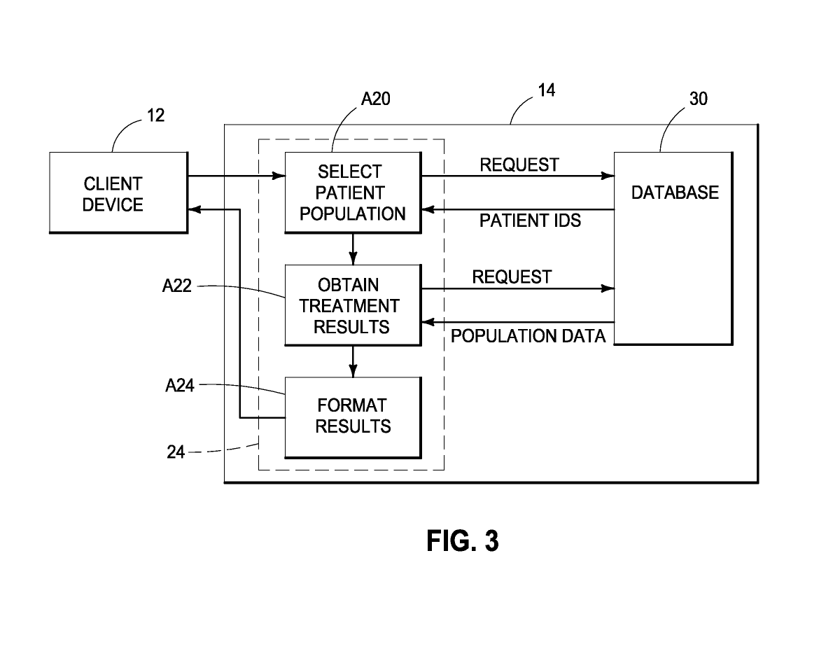

Referring to FIG. 2, details of one example embodiment of a client device 12 in the form of a personal or notebook computer is shown. In the depicted example, the client device 10 includes a user interface 22, processing circuitry 24, storage circuitry 26 and a communications interface 28. Other configurations of client device 10 are possible including more, less and/or alternative components. Medical information system 14 may also be configured to include the components depicted in FIG. 2 in one example embodiment.

User interface 22 is configured to interact with a user including conveying data to a user (e.g., displaying visual images for observation by the user) as well as receiving inputs from the user, for example via a keyboard and point device (e.g., mouse). User interface 22 is configured as graphical user interface (GUI) in one example embodiment.

In one embodiment, processing circuitry 24 is arranged to process data, control data access and storage, process data to generate reports, issue commands, and control other desired operations. Processing circuitry 24 may comprise circuitry configured to implement desired programming provided by appropriate computer-readable storage media in at least one embodiment. For example, the processing circuitry 24 may be implemented as one or more processor(s) and/or other structure configured to execute executable instructions including, for example, software and/or firmware instructions. Other exemplary embodiments of processing circuitry 24 include hardware logic, PGA, FPGA, ASIC, state machines, and/or other structures alone or in combination with one or more processor(s). These examples of processing circuitry 24 are for illustration and other configurations are possible.

Storage circuitry 26 is configured to store programming such as executable code or instructions (e.g., software and/or firmware), electronic data, databases, image data, electronic reports or other digital information and may include computer-readable storage media. At least some embodiments or aspects described herein may be implemented using programming stored within one or more computer-readable storage medium of storage circuitry 26 and configured to control appropriate processing circuitry 24.

The computer-readable storage medium may be embodied in one or more articles of manufacture 27 which can contain, store, or maintain programming, data and/or digital information for use by or in connection with an instruction execution system including processing circuitry 24 in the exemplary embodiment. For example, exemplary computer-readable storage media may include any one of physical media such as electronic, magnetic, optical, electromagnetic, infrared or semiconductor media. Some more specific examples of computer-readable storage media include, but are not limited to, a portable magnetic computer diskette, such as a floppy diskette, a zip disk, a hard drive, random access memory, read only memory, flash memory, cache memory, and/or other configurations capable of storing programming, data, or other digital information.

Communications interface 28 is arranged to implement communications of client device 12 with respect to external devices (such as medical information system 14). For example, communications interface 28 may be arranged to communicate information bi-directionally with respect to external devices. Communications interface 28 may be implemented as a network interface card (NIC), serial or parallel connection, USB port, Firewire interface, flash memory interface, or any other suitable arrangement for implementing communications with respect to external devices.

As mentioned above, client devices 12 may be used by medical personnel during patient examinations to obtain and record information pertinent to the health of the patient. The recorded data, for example including data regarding patient characteristics of a subject patient being treated, may be processed by the respective client device 12 or medical information system 14 and the results of the processing may aide in a determination of appropriate courses of treatment in the future. Example details of the processing are described below. In one more specific embodiment, the processing of the patient data may be implemented within system 14, and the results of the processing may be provided back to an appropriate one or more of the client devices 12 to assist medical personnel with the treatment of patients according to one embodiment.

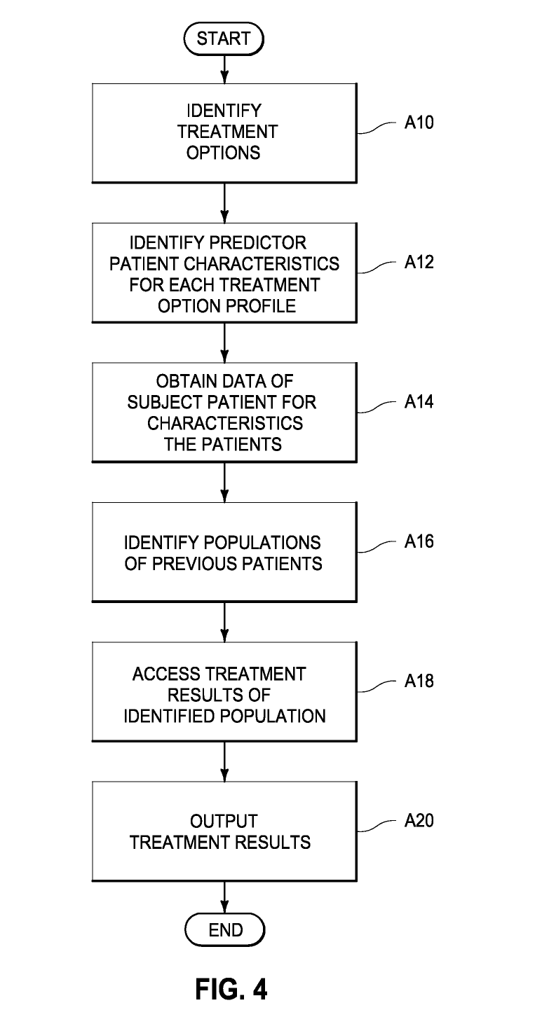

Referring to FIG. 3, example operations of processing patient treatment data to provide information to assist with treatment of a subject patient are described. In the example of FIG. 3, the processing may be implemented by processing circuitry 24 with access to a database 30 of data warehouse 18 which stores de-identified patient treatment data of the subject patient as well as previous patients who have been treated for a common medical condition according to one embodiment.

A client device 12 of a medical provider communicates patient data (including values for a plurality of patient characteristics of the subject patient being treated for a medical condition and disease activity metrics or measures for the medical condition) to the medical information system 14. Processing circuitry 24 of the medical information system 14 forwards requests to database 30 which include the subject patient's data (e.g., values) for the patient characteristics and disease activity metrics, and processing circuitry of the database 30 (not shown) uses the values of the data to identify a population of previous patients with similar data values for the patient characteristics and disease activity measures who have been previously treated for the same medical condition as indicated by an act 20 (i.e., similar previous patients to the subject patient being treated).

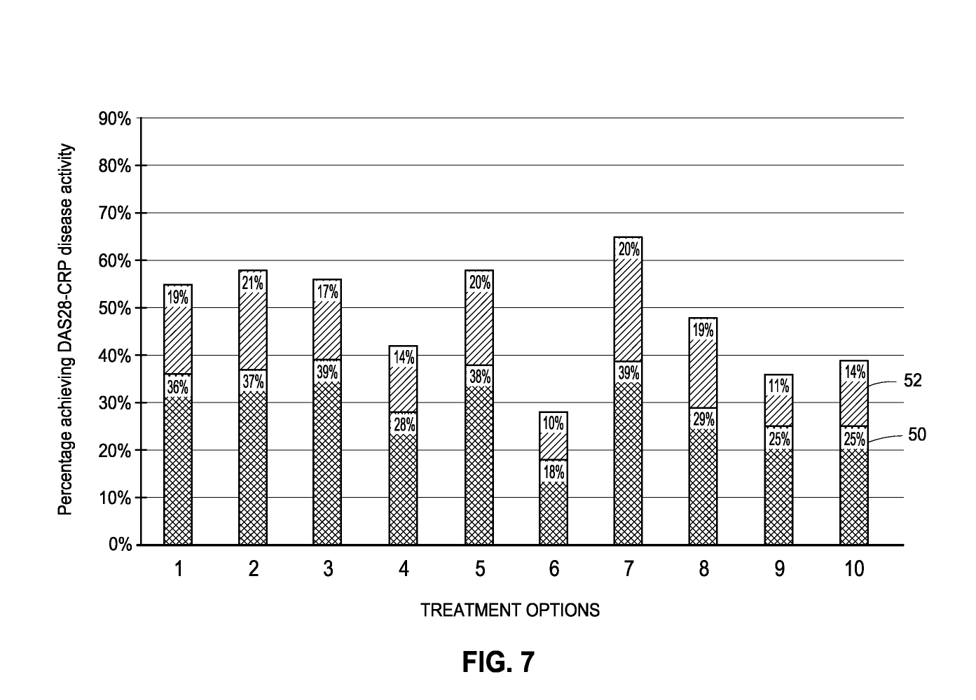

A list of patient identification numbers of the determined patient population are returned as a result of the searching. Additional details regarding one embodiment of searching the previous patients within the database to identify the appropriate population are described below with respect to FIG. 6.

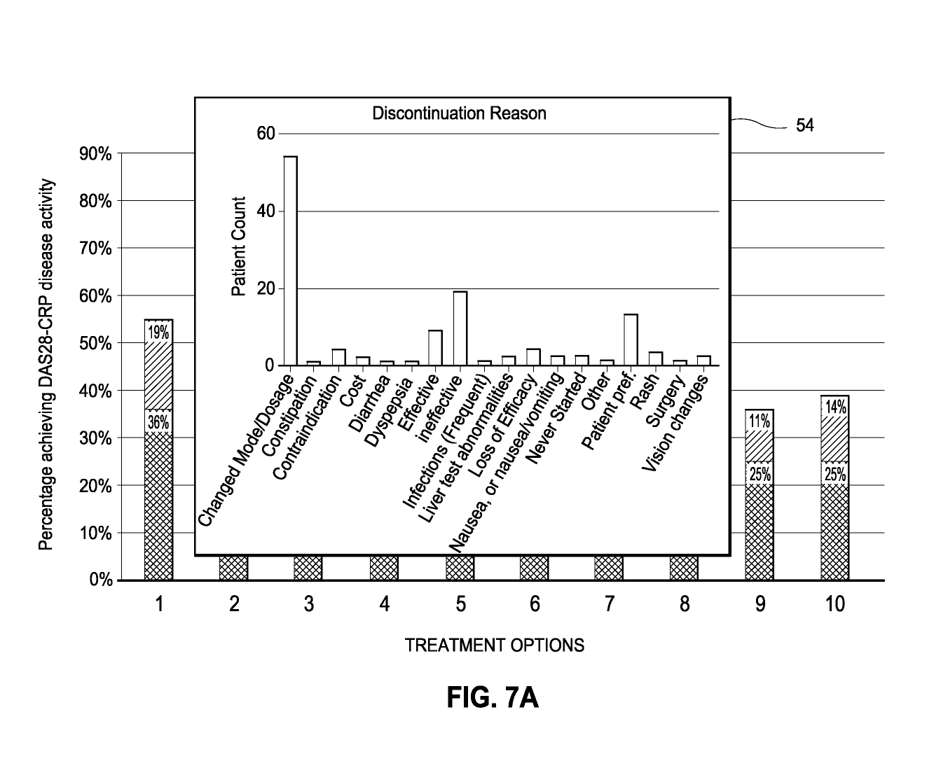

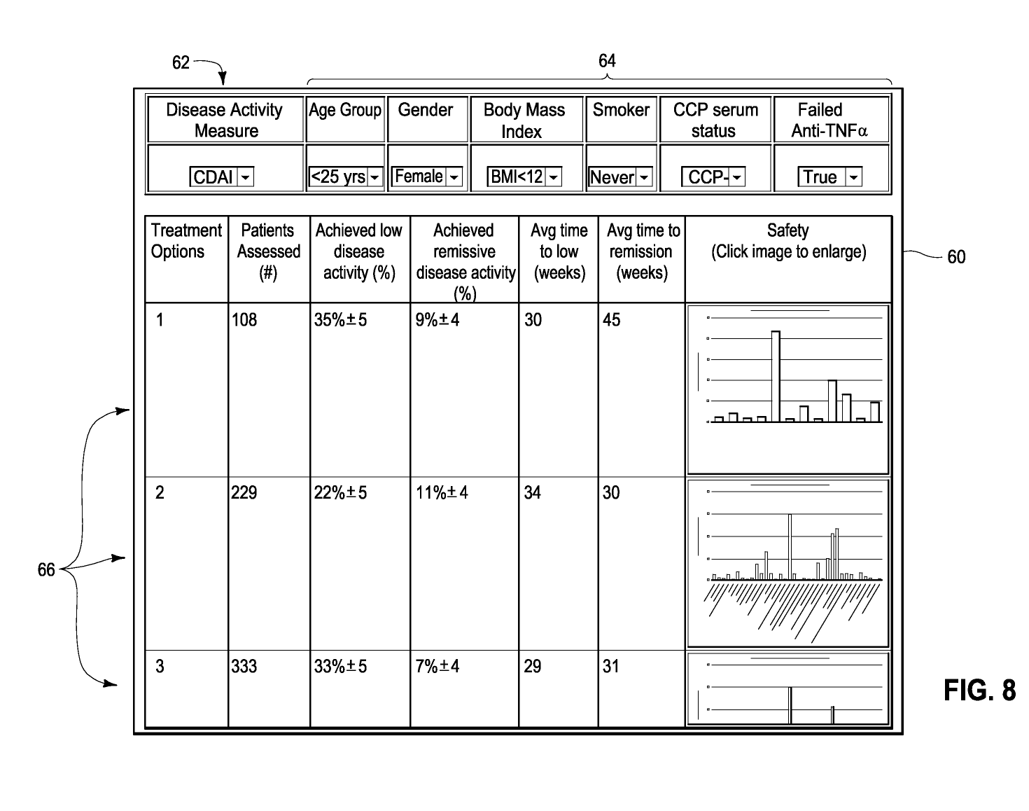

The processing circuitry at an act A22 obtains treatment results of the identified population of previous patients from the database 26. In one example, the patient identifiers of the population of previous patients may be submitted to database 30 in a request to retrieve data of treatment results of the population of similar previous patients. In one embodiment, the data of the treatment results includes information regarding effectiveness (e.g., low disease activity or remission) and safety (e.g., reasons for discontinuing treatment) of a plurality of different treatment options for treating the medical condition of the subject patient. The treatment results for the identified population may be organized and formatted at an act A24 and communicated to the appropriate client device 12 of the physician treating the subject patient. Additional details regarding display and use of treatment results are described below with respect to FIGS. 7, 7A and 8.

As discussed above, a number of possible treatment options may be available to treat a medical condition of a subject patient. Some of the described embodiments use data of patient characteristics and disease activity measures of the subject patient to identify a population of similar patients as also discussed above. However, different ones of the patient characteristics (i.e., predictor patient characteristics) may have increased correspondence or relevance regarding treatment of the previous patients using a respective treatment option compared with others of the patient characteristics. Furthermore, different predictor patient characteristics may be identified for the different treatment options.

In illustrative examples, the predictor patient characteristics may be indicative of effectiveness and safety of treatment options for the subject patient to be treated while less relevant patient characteristics may provide little or no insight as to how the subject patient will respond to the treatment option. In one embodiment, previous treatment results of the previous patients may be processed to select appropriate predictor patient characteristics for each of the treatment options. In an additional example, a given treatment option may also be evaluated with respect to plural disease activity metrics, and accordingly, different predictor patient characteristics may be identified for the same treatment option and the respective different disease activity metrics.

In two illustrative example methods, the predictor patient characteristics most relevant to effectiveness and safety are generated automatically in real time by predefined data mining algorithms or by using multivariate statistical analysis which identifies the predictor patient characteristics that exist statistically and are highly correlated with medication effectiveness and safety outcomes.

In one more specific embodiment, processing circuitry (e.g., of one of clients 12 or medical information system 14) may process treatment results of previous patients stored in the database 30 to identify, for each treatment option (and an associated disease activity metric), one or more predictor patient characteristics which are statistically significantly correlated with the effectiveness and safety of the respective treatment option. The predictor patient characteristics which are identified are key determinants of whether or not a particular treatment option will be effective in reducing disease activity (e.g., to low disease activity or remission) and safe for use.

As mentioned above, these identified patient characteristics may be referred to as predictor patient characteristics, and different patient characteristics are typically identified as predictor patient characteristics for the different treatment options and disease activity metrics. Once the predictor patient characteristics are identified, data values for the subject patient for the identified different predictor patient characteristics are used to predict the effectiveness and safety of the different treatment options with respect to the subject patient.

In one embodiment, the predictor patient characteristics for each of the treatment options (e.g., medications) may be stored in a plurality of respective treatment option profiles. Some examples of treatment option profiles for pairs of medications and disease activity metrics are displayed as rows in Table A and which may also be referred to as metric pairs.

TABLE A

| | Disease | |
|---|---|---|
| Medication | Activity Metric | Characteristic Combination |
| Enbrel | CDAI | RF serum status |
| Enbrel | SDAI | Age, Gender, and Interstitial Lung Disease |
| Rituxan | DAS28 | CCP serum status, Years since diagnosis |
| Rituxan | DAS28-CRP | CCP serum status, Swollen joint count >5 |

Accordingly, a metric pair includes the treatment option (e.g., medicine name or combination of medicines) and a disease activity metric which was used to identify the one or more relevant patient characteristics for the given treatment option profile. The profiles additionally include the corresponding one or more identified predictor patient characteristics.

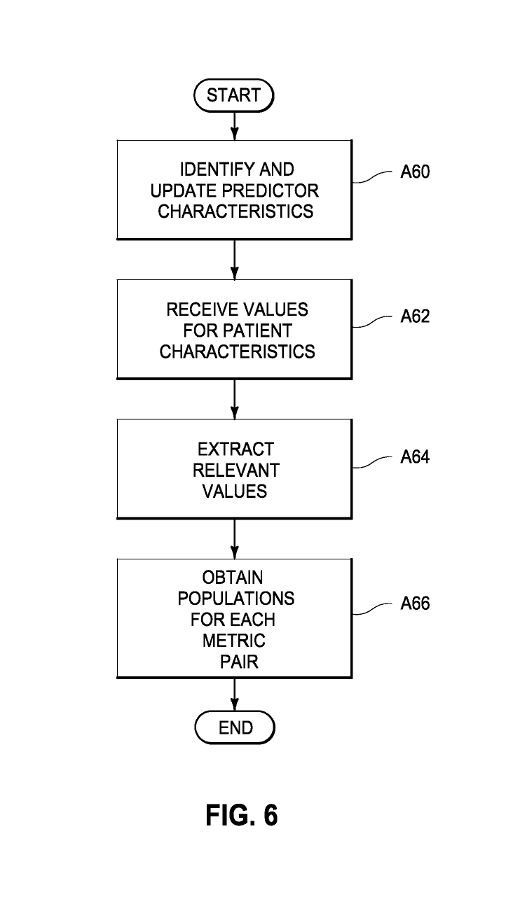

A given treatment option (e.g., Enbrel above) may have a plurality of treatment option profiles, one for each of the different disease activity metrics (e.g., CDAI and SDAI), as well as the corresponding one or more patient characteristics identified by application of the respective disease activity metric. As can be seen from the Table A, different predictor patient characteristics may be identified for the same treatment option resulting from the use of different disease activity metrics. Additional details regarding processing to identify the patient characteristics for the respective treatment options for the different disease activity metrics are described below with respect to FIG. 5.

Although not shown in Table A, each of the rows corresponding to the respective treatment option profiles can also include relevance variables which may be used to select the predictor patient characteristics for each of the treatment option profiles. In one embodiment, relevance variables include statistical significance scores (p-values) and coefficients of determination (r-values) which may be used to determine which patient characteristics are predictor patient characteristics for the treatment option profiles. The relevance variables may be utilized to compare the different combinations of patient characteristics to identify combinations of the characteristics which are more optimal than other combinations and which are the predictor patient characteristics for a given metric pair.

The treatment option profiles may be stored within medical information system 14 and requested by a client device 12 when a subject patient is to be treated. The treatment option profiles may be used to select populations of previous patients having data values for the appropriate predictor patient characteristics which are similar to the subject patient for the respective metric pairs to assist with the selection of the appropriate treatment options as discussed further below. Furthermore, the treatment option profiles and predictor patient characteristics may change dynamically as new patient information is received over time within the medical information system 14 as described further below.

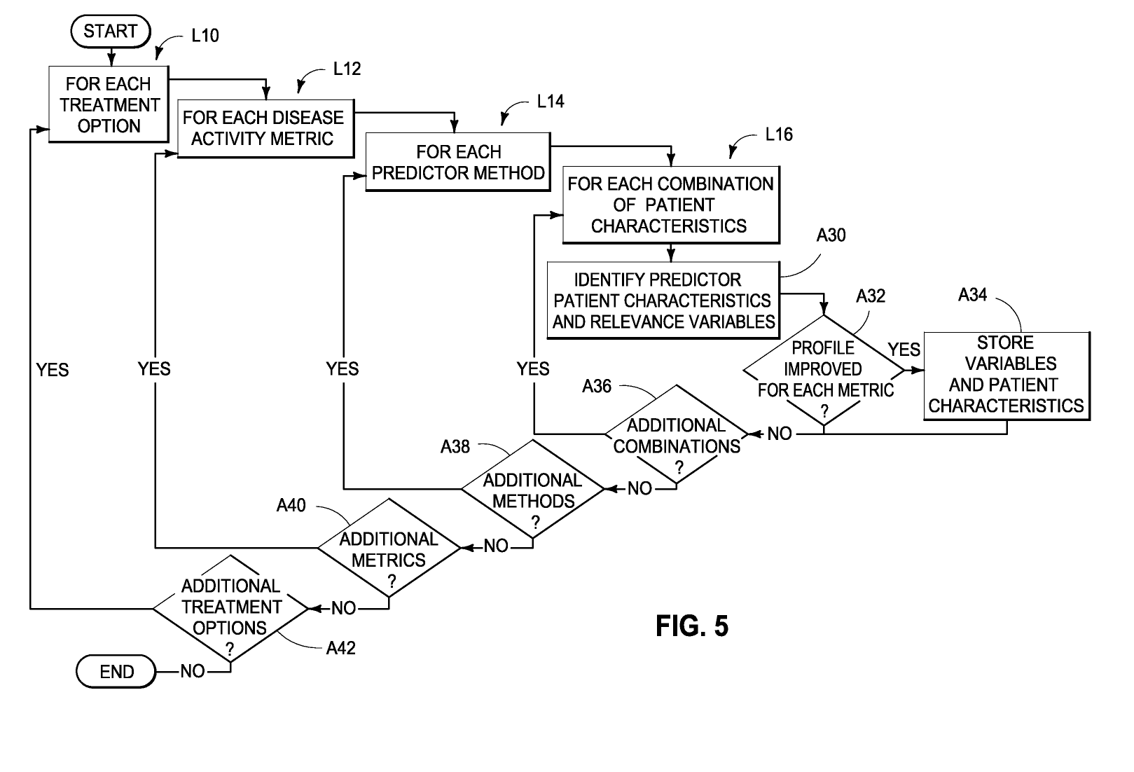

Referring to FIG. 4, a medical treatment method is shown to assist medical personnel with treatment of a medical condition of a subject patient according to one embodiment. The method may be implemented by processing circuitry of one or both of client devices 12 and medical information system 14 in an example embodiment. Other methods are possible including more, less and/or alternative acts.

At an act A10, a medical condition for a subject patient is identified for treatment, and a plurality of treatment options for treating the medical condition are also identified. The treatment options may be different medicines or combinations of medicines for treating the medical condition and may be identified by the physician or recalled from a database in illustrative examples.

At an act A12, the medical information system may process patient treatment results to provide the specific predictor patient characteristics of the treatment option profiles. In one embodiment, the profiles are updated over time as new data is received, and accordingly, the specific predictor patient characteristics for the respective treatment option profiles and metric pairs may change over time. The relevance variables may be calculated and used to determine the predictor patient characteristics for the treatment option profiles in one embodiment. Additional details regarding identification of the predictor patient characteristics are described below, for example with respect to FIG. 5.

At an act A14, the data (e.g., values) of the relevant patient characteristics for each of the treatment option profiles may be retrieved from the data received from the subject patient being treated. In one embodiment, data for each of the patient characteristics of Appendix A and/or others may be obtained by a medical provider and submitted to the medical information system. The medical information system may extract the values for appropriate patient characteristics for one or more treatment option profiles being considered for treatment.

At an act A16, the medical information system identifies a plurality of populations of previous patients who have already been treated for the medical condition of the subject patient and which correspond to respective ones of the treatment option profiles. In one embodiment, the previous patients of the identified populations remain anonymous and are only identified by patient identification numbers.

At an act A18, the medical information system accesses treatment results from the data store for each of the identified populations of previous patients for each of the treatment option profiles. The treatment results may include information regarding effectiveness and safety for each of the treatment options. Since the treatment results were obtained from previous patients who belong to the identified populations which are similar to the subject patient, the treatment results for these previous patients may be indicative of effectiveness and safety of the various treatment options of the subject patient.

At an act A20, the treatment results may be communicated to the appropriate client device 12 for use by medical personnel in determining an appropriate treatment option for treating the medical condition of the subject patient. In addition, the treatment results may be used for additional patient education and counseling, for example, to recommend lifestyle changes. For example, if the subject patient is a smoker, the value of the smoker patient characteristic may be changed to a non-smoker and a new population of previous patients and corresponding treatment results may be obtained to attempt to illustrate the benefits of quitting smoking to the subject patient.

Referring to FIG. 5, an example method to determine predictor patient characteristics for each of the treatment option profiles corresponding to the metric pairs is shown. The method may be implemented by processing circuitry of one or both of a client device 12 and medical information system 14 in an example embodiment.

The example method of FIG. 5 includes a plurality of nested loops where, for each metric pair (i.e., treatment option and disease activity metric), a plurality of predictor methods will be executed with every possible combination of patient characteristics. The results of the processing identifies, for each of the different metric pairs, one or more predictor patient characteristics, for example, as shown in Table A, as well as a plurality of relevance variables. As mentioned above, the relevance variables may include statistical significance scores (p-values) and coefficients of determination (r-values) and which may be used for evaluation of the different combinations of patient characteristics to determine the optimal combinations of patient characteristics to be used as predictor patient characteristics of the metric pairs for the respective treatment option profiles. Other methods are possible including more, less and/or alternative acts.

At a loop L10, the method is executed with respect to each of the possible treatment options (e.g., a medicine or combination of medicines).

At a loop L12, for each treatment option, the method is executed for a plurality of disease activity metrics (e.g., CDAI, SDAI, etc.).

At a loop L14, for each disease activity metric, the method is executed for a plurality of predictor methods. Example predictor methods which may be used include R's LM regression described in R Core Team, R: A Language and Environment for Statistical Computing, R Foundation for Statistical Computing, Vienna, Austria, ISBN 3-900051-07-0, http://www.R-project.org/ (2012); WEKA's classification algorithms, such as linear regression, described in Mark Hall, Eibe Frank, Geoffrey Holmes, Bernhard Pfahringer, Peter Reutemann, Ian H. Witten, The WEKA Data Mining Software: An Update, SIGKDD Explorations, Volume 11, Issue 1 (2009); Microsoft Clustering or Association described in Data Mining Algorithms (Analysis Services-Data Mining), Microsoft, URL http://technet.microsoft.com/en-us/library/ms175595.aspx (2014); and Excel's Multi-Variate Regression described in Use the Analysis ToolPak to Perform Complex Data Analysis, Microsoft, URL http://office.microsoft.com/en-us/excel-help/use-the-analysis-toolpak-to-perform-complex-data-analysis-HP010342762.aspx (2014), the teachings of all of which are incorporated herein by reference.

In one embodiment for assessing effectiveness, the predictor inputs to each of the algorithms above are comprised of an array of patient characteristics as described in the Appendix A or derivatives therefrom (e.g. based upon date/time). The dependent outputs are the disease activity states associated with a disease activity metric. In one embodiment for assessing safety, the predictor inputs include any of the characteristics described in the Appendix A, while the dependent outputs include mathematical summaries (e.g. percentages) of the counts of discontinuation reasons and adverse events of the selected patient population.

At a loop L16, for each predictor method, the method is executed for all different combinations of the patient characteristics. In one embodiment, for each treatment option (e.g. a medication Enbrel) and each disease activity metric (e.g., CDAI), each analysis algorithm (e.g. Linear Regression) will be run with every possible combination of patient characteristics. These algorithms will identify predictor patient characteristics and the relevance variables for each of the metric pairs. In particular, for every metric pair, predictor patient characteristics and their relevance variables are identified at an act A30 during the executions of the loops L10, L12, L14, L16. In one embodiment, the relevance variables are used to compare the different combinations of patient characteristics and select the predictor patient characteristics.

An execution of loop L16 ends when the last combination of patient characteristics is processed at act A30 for the respective predictor method, an execution of loop L14 ends when the last predictor method is processed at act A38 for the respective disease activity metric, an execution of loop L12 ends when the last disease activity metric is processed at act A40 for the respective treatment option, and an execution of loop L10 ends at act A42 when the loops L12, L14, L16 of the last treatment option are fully processed.

After the first initial execution of the method of FIG. 5, the relevance variables for the different combinations of patient characteristics for each metric pair are compared with one another. The combination of patient characteristics which provides the smallest statistical significant score and the largest coefficient of determination is selected as the combination of predictor patient characteristics for the respective metric pair in one embodiment.

In one embodiment, the method of FIG. 5 may be continually executed or executed repeatedly to process new incoming data (i.e., new patient treatment data received within the medical information system 14), and the treatment option profiles/predictor patient characteristics for the metric pairs may be updated if appropriate. For example, if the relevance variables from one of the executions are improved compared to an existing treatment option profile, then the new predictor patient characteristics and respective relevance variables are stored for the treatment option profile. In one embodiment, for newly identified patient characteristics using new data, if the p-value is less than the p-value of the existing treatment option profile for the metric pair and the r-value is greater than the r-value of the existing treatment option profile for the same metric pair, then the treatment option profile in the data warehouse is updated with the associated patient characteristics (which become the new predictor patient characteristics) and the associated relevance variables which are used for subsequent comparisons.

Referring to FIG. 6, an example method to determine an appropriate population of previous patients to a subject patient for treatment option profiles is shown. The method may be implemented by processing circuitry of one or both of a client device 12 and medical information system 14 in an example embodiment. Other methods are possible including more, less and/or alternative acts.

At an act A60, the predictor patient characteristics for the different treatment option profiles are updated at a plurality of moments of time as discussed above, including continuously in one specific embodiment. A client device 12 of medical personnel treating the subject patient may submit a request to the system 14 and the system 14 may return the current predictor patient characteristics which are being used for the treatment option profiles at the respective different moments in time. As mentioned previously, the predictor patient characteristics for a given treatment option profile may be updated, and accordingly, may be different at different moments in time based upon dynamic receipt of new treatment results of the previous patients.

At an act A62, data values of the patient characteristics are obtained from a subject patient being treated. In one example, the data values are obtained from laboratory results and patient answers resulting from a patient encounter.

At an act A64, the appropriate data values for the subject patient are extracted for the predictor patient characteristics which were identified in act A60. These extracted data values are used to formulate population requests to identify populations of similar previous patients for each treatment option profile. The population request identifies the treatment option profile for which the population is requested and includes the data values of the subject patient for the predictor patient characteristics of the treatment option profile. The database of the data warehouse is searched using the information of the request and a list of patient identifiers is obtained for the previous patients which are determined to be similar to the current patient based upon the data values of the subject patient for the respective predictor patient characteristics.

Example processing to determine a population of similar previous patients is described below according to one embodiment although other embodiments are possible. In one embodiment, the database of the data warehouse is searched for de-identified previous patients with similar or matching predictor patient characteristics to the subject patient. Each of the patients' characteristics may be classified as being one of the following types of data types: Boolean, Nominal, Continuous and Date/Time. Some of the patient characteristics may be analyzed as either continuous or nominal depending on how the data is used. The patient characteristics of the subject patient are matched to the patient characteristics of each of the previous patients according to one embodiment.

Example similar or matching guidelines are described below, although other guidelines can be used in other embodiment. Boolean data types have one of two values. According to one guideline, if the subject patient's Boolean characteristic is true, the de-identified previous patients must also have the same characteristic set as true in one embodiment. Likewise if the subject patient's Boolean characteristic is false, then the de-identified previous patients must also have the same characteristic set as false in one embodiment.

Nominal data types represent named groups of values that a characteristic can have. Similar to the Boolean data types, nominal values must match exactly between the subject patient and the de-identified previous patient records searched in one embodiment.

Date/time data types are typically by themselves not useful until a calculation referring to another date/time is performed to identify the difference/relationship between the two dates (e.g. finding the number of days between two encounters). Therefore the date/time values may not be directly referenced but comparisons of the values may be used (e.g., to determine a calculated age of a subject patient and which can be compared to the calculated ages of de-identified previous patients). These calculated ages may fall into the category of continuous variables.

Continuous data types are versatile and can be used in numerous ways. Many comparisons of continuous data between two patients will not be looking for an exact match where the de-identified previous patient must have the exact same value for a predictor patient characteristic as the query subject patient. Instead, a range of acceptable values centered upon the specific subject patient continuous value may be used in one embodiment. The third column of the Appendix A provides high-level names which describe how appropriate ranges are identified for each population request in one embodiment. If a de-identified patient characteristic falls with the respective range of the subject patient, then a match is said to have occurred.

One of the methods used to calculate ranges is developing “bins” as typically used in the building of histograms. Bins can either be manually created or generated using pre-defined algorithms. Typically, the bin size will be determined via an automated algorithm. One example algorithm which may be used is Freedman-Diaconis built into the software package R discussed in the reference A Language and Environment for Statistical Computing which is incorporated by reference above. The bins are derived from the treatment data of de-identified previous patients in the database in one embodiment. Other methods (e.g., standard deviation) may be used in other embodiments.

At an act A66, the data store returns a population list of previous patients contained within the database for each of the treatment option profiles. Data for the returned list of previous patients may be used to select an appropriate treatment of the subject patient in one embodiment. For example, the returned data of the population may be provide information regarding the effectiveness and safety of the associated treatment option profile. Effectiveness may be defined by the percentage of similar previous patients who achieved low disease activity or remission as a result of the respective treatment option.

Example effectiveness calculations identify the total number of patients treated using a particular treatment option and identify the percentage of patients in a particular disease activity state (e.g. remission or low as defined for the applicable medical condition) along with an average number of weeks to low or remission for the respective population in one embodiment. In particular, percentages of patients in the population that achieved remission, low, moderate, and high disease activity states for all disease activity metrics are calculated along with a 95% confidence interval in one embodiment.

In one embodiment, the results may be automatically prioritized. In one example, the treatment options may be ordered first by the largest group achieving remission by percentage and then the rest in descending order. In addition, all reasons for discontinuation of the treatment option are tallied for the same patient population for the respective treatment option profile in one embodiment. The calculated results may be returned to client device 12 for display and use by medical personnel treating the subject patient.

Referring to FIG. 7, a graphical representation of the effectiveness of a plurality of treatment options is shown for a DAS28-CRP disease activity metric and which may be depicted on a display screen of client device 12 in one embodiment. In one example, the system 14 may calculate the illustrated data and forward the data to client device 12 for display in a web-browser to the medical personnel. In one embodiment, a total percentage of the previous patients meeting low and remission activity levels are shown and the respective illustrated bars additionally show the portions of the total which are low disease activity 50 and in remission 52. In one embodiment, medical personnel may review the information of the graphical representation for assistance in selecting one of the treatment options.

Referring to FIG. 7A, a window 54 of safety information/discontinuation reasons may be observed by the medical personnel to assist with the selection of one of the treatment options. The window 54 displays the number of patients which discontinued the treatment option (e.g., particular medicine) for a plurality of different reasons. At least some of the reasons may be used by the medical personnel and subject patient to select an appropriate one of the treatment options.

Referring to FIG. 8, a graphical user interface 60 is shown which may also be used to assist with the selection of a treatment option. The illustrated example interface 60 is a personalized medication comparison chart (PMCC) directed towards treatment of rheumatoid arthritis or spondyloarthropathies that, based on a subject patient's characteristics, provides in real-time a list of treatment options (e.g., immunomodulators) sortable by their relative effectiveness, time to a defined efficacy outcome, and safety, and additionally which is based on populations of previous patients in the database which have similar patient characteristics and the same medical condition as the patient being treated. The example illustrated interface 60 for treating rheumatoid arthritis or spondyloarthropathies shows effectiveness of treatment options (i.e., medications or biologics) returned from the data warehouse. Different medications for treating other previous patients having similar characteristics are shown on the y-axis while percentages of the other previous patients in the database achieving low or remissive DAS28-CRP disease activity are shown on the x-axis.

The top portion of the example interface 60 illustrates information which may change (i.e., the selected disease activity metric 62 and the patient characteristics 64) while the lower portion displays the treatment options 66 and associated treatment data from the previous patients for the selected disease activity metric and patient characteristics. Medical personnel may select one or more different disease activity metrics (e.g., based upon personal preference) and review the respective results to determine an appropriate treatment option in one embodiment.

Changing any of the values for the patient characteristics 64 in the top portion will cause a re-calculation and re-display of the results taking that new data value into account. Accordingly, in one embodiment, the graphical user interface 60 may be utilized by the medical personnel to discuss lifestyle changes with the subject patient. For example, if the subject patient is a smoker, the patient characteristic may be changed to non-smoker which will result in the selection of a new population of previous patients and the respective data of the population processed and the results may be displayed.

Each of the displayed treatment options 66 contains a plurality of cells which contain the calculated data items based upon the selected previous patient populations for the different treatment options. In one embodiment, the user is able to sort the results by clicking on the name of the column. In the depicted example, the rightmost column includes graphs of the discontinuation reasons which were discussed above for each of the treatment options. By clicking in a right-most cell, a window similar to window 54 of FIG. 7A is generated which displays the discontinuation reasons for the particular treatment option. In addition to the count of each type of discontinuation, a percentage of all discontinuation reasons each discontinuation reason constitutes is also displayed in one embodiment. The illustrated interface 60 is one possible example and the data may be conveyed to the medical personnel using different interfaces in other embodiments. The medical personnel and the subject patient may use the interface 60 and information contained therein to select an appropriate one of the possible treatment options.

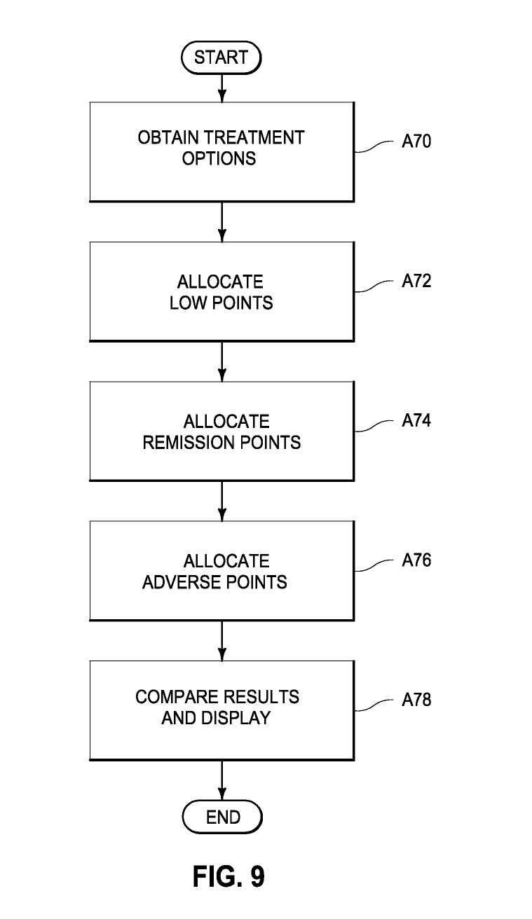

Referring to FIG. 9, a flow chart of a method to compare the treatment options with respect to one another is illustrated according to one embodiment. The method may be executed by processing circuitry of system 14 in one embodiment. Other methods are possible include more, less and/or additional acts.

The method ranks and recommends a plurality of possible treatment options for treating a medical condition to physicians for consideration. The described method is one possible embodiment of how scores of the treatment options can be aggregated. At a high level, this method weights low disease activity higher than remission disease activity results as patients are more likely to achieve low disease activity than remission. Points are awarded and the treatment options with the highest scores rank highest as recommendations for the physician to consider. In the described example, more points are given to the treatment options where the percentage of patients achieving low disease activity or remission is greater than other treatment options, more points are allocated to treatment options whose average time to achieving low disease activity or remission is lower than other treatment options, more points are allocated to a treatment option whose duration in either low disease activity or remission is longer than other treatment options, and more points are allocated to a treatment option whose number of adverse events are lower than other treatment options. Other methods may be used in other embodiments.

In one embodiment, prior to the start of this method, comparative effectiveness results (CERs) are calculated for each treatment option as described previously and illustrated in FIG. 8. The acts below are based upon those results in the described embodiment.

At an act A70, treatment options that are desired (e.g., medications such as Bioloigcs and DMARDs) to be part of the comparison are selected. This includes allowing the user (e.g. a physician) to select specific treatment options. By default only treatment options that have comparative effectiveness results for greater than 50 patients are included for consideration although this can be overridden by the user. Subsequently, an individual treatment option counter (Mᵢ) of total points for each treatment option is created and set to zero.

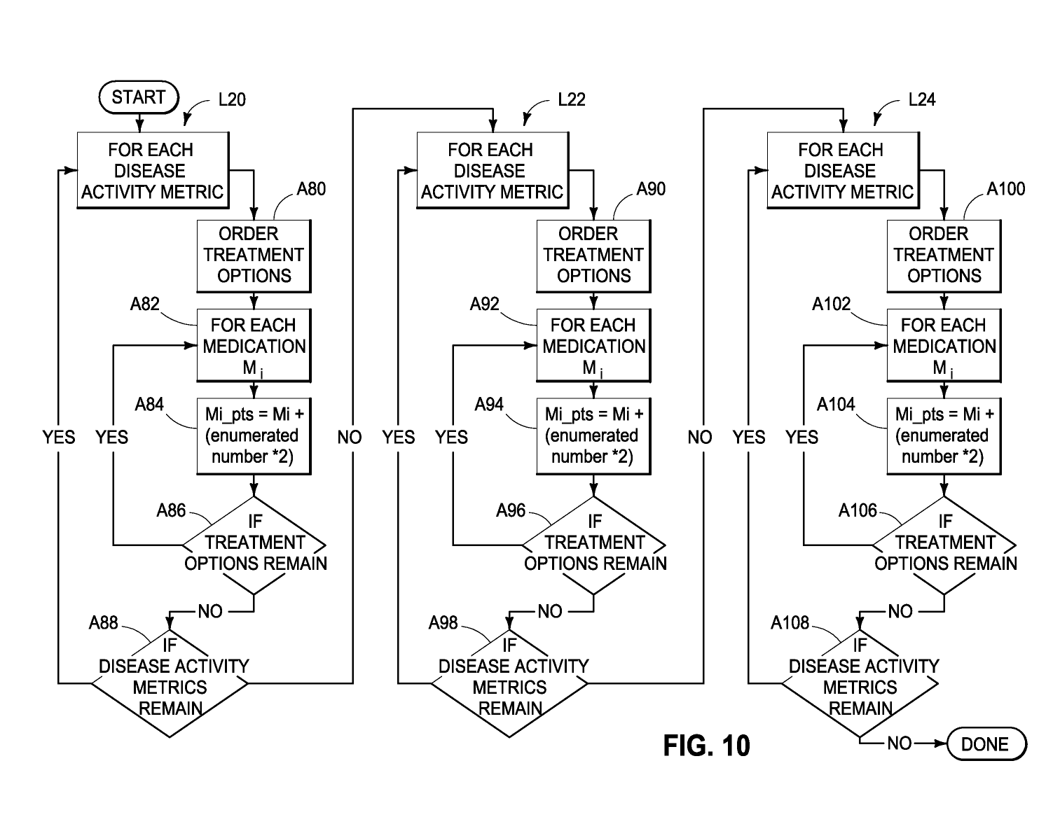

At an act A72, points for low disease activity are allocated to the treatment options as described below with respect to the example method of FIG. 10.

At an act A74, points for remission are allocated to the treatment options using the example method of FIG. 10.

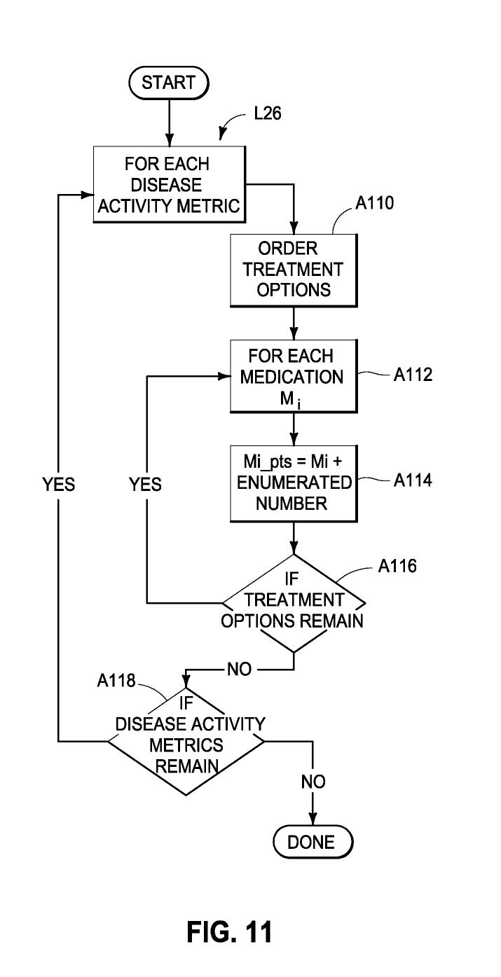

At an act A76, points for adverse events are allocated to the treatment options as described below with respect to the example method of FIG. 11.

At an act A78, once all the treatment options have been scored for each of the disease activity metrics, the individual treatment option counters can be compared to determine which has the highest number of points. The treatment options are then displayed (along with their scores) in descending order of points in the described example embodiment. The medical personnel may use the displayed results to select an appropriate one of the treatment options to treat the subject patient.

FIG. 10 is a flow chart of a method to allocate points for low disease activity for the treatment options according to one embodiment. This method may also be used to allocate points for remission for the treatment options as described below. For each disease activity metric, the comparative effectiveness results for each treatment option are sorted according to each of the factors described below. The sorted treatment options are subsequently enumerated (starting at 1 and increasing by a value of 1). The enumeration value is employed in calculating the points to be added to the current treatment option counter total.

At a loop L20, the results are analyzed for each of the disease activity metrics including the percentage of patients in the respective populations which achieved low disease activity.

At an act A80, in one embodiment, the treatment options are ordered and enumerated according to the comparative effectiveness results from the lowest percentage achieving low disease activity to highest percentage achieving low disease activity.

At an act A82, each treatment option is selected one by one.

At an act A84, the score to be added to the respective treatment option counter is the enumeration value for the given treatment option*2 (i.e., Mi_pts=Mi+(enumerated number*2). Thus, as the enumeration value increases so does the number of points added to the treatment option counter. The treatment options which helped larger percentages of patients obtain low disease activity receive greater points.

At an act A86, the counters for any remaining treatment options are adjusted at additional executions of act A84.

At an act A88, the loop L20 terminates if no additional treatment options remain to be analyzed.

At a loop L22, the results are analyzed for each of the disease activity metrics including the average time for the relevant population to achieve low disease activity.

At an act A90, in one embodiment, the treatment options are ordered and enumerated according to the comparative effectiveness results having the longest average time to low disease activity to the shortest average time to low disease activity.

At an act A92, each treatment option is selected one by one.

At an act A94, the score to be added to the respective treatment option counter is the enumeration value for the given treatment option*2 (i.e., Mi_pts=Mi+(enumerated number*2). Thus, the treatment options with the greatest period of time to low disease activity receive fewer points.

At an act A96, the counters for any remaining treatment options are adjusted at additional executions of act A94.

At an act A98, the loop L22 terminates if no additional treatment options remain to be analyzed.

At a loop L24, the results are analyzed for each of the disease activity metrics including the average duration of length of time in low disease activity.

At an act A100, in one embodiment, the treatment options are ordered and enumerated according to the comparative effectiveness results having the shortest to longest duration of low disease activity.

At an act A102, each treatment option is selected one by one.

At an act A104, the score to be added to the respective treatment option counter is the enumeration value for the given treatment option*2 (i.e., Mi_pts=Mi+(enumerated number*2). Thus, the treatment options with the shortest durations in low disease activity receive fewer points.

At an act A106, the counters for any remaining treatment options are adjusted at additional executions of act A104.

At an act A108, the loop L24 and method of FIG. 10 terminate if no additional treatment options remain to be analyzed.

In one embodiment, the process for allocating points for the treatment options which achieved remission is similar to the process for allocating points for the treatment options which achieved low disease activity described above with respect to FIG. 10. In one embodiment, the points allocated to the treatment options based on remission are equivalent to the enumerated value (and are not multiplied by 2 as is the case of allocation of points for low disease activity). Accordingly, the formula of acts A84, A94 and A104 would be Mi_pts=Mi+enumerated number for allocating points for the treatment options which achieved remission.

FIG. 11 is a flow chart of a method to allocate points for adverse events according to one embodiment.

At a loop L26, the treatment results of the relevant patient populations are analyzed with respect to the adverse event counts for each of the disease activity metrics. Example adverse events include: Fatigue/malaise, Fever, Headache, Insomnia, Rigors, Chills, Sweating, Weight gain, Weight loss, Cataract, Conjunctivitis, Lacrimation increased, Retinopathy, Vision changes, Xerophthalmia, Hearing loss, Sense of smell, Sinusitis, Stomatitis, Taste disturbance, Tinnitus, Voice changes, Xerostomia, Arrhythmia/Tachycardia, Cardiac function decreased, Edema, Hypertension, Hypotension, Myocardial ischaemia, Pericarditis/pericardial effusion, Phlebitis/thrombosis/embolism, Alopecia, Bullous eruption, Dry skin, Hives (Urticaria), Injection site reaction, Petechiae, Photosensitivity, Pruritis, Psoriasis, Rash, Thickening, Asthma, Cough, Dyspnea, Pleuritic pain, Pneumonitis, Pulmonary function decreased, Anorexia, Bowel Perforation, Constipation, Diarrhea, Diverticulitis, Dyspepsia, GI bleed, Hematochezia, Hepatitis, Jaundice, Liver test abnormalities, Nausea, or nausea/vomiting, Pancreatitis, Proctitis, Reflux, Arthralgia, Avascular necrosis, Leg cramps, Myalgia, Allergic reaction/hypersensitivity, Autoimmune reaction, Rhinitis, Serum sickness, Vasculitis, Anxiety or depression, Cerebrovascular ischemia, Cognitive disturbance, Depressed consciousness, Inability to concentrate, Insomnia, Libido decreased, Peripheral motor neuropathy, Peripheral sensory neuropathy, Seizure, Vertigo, Anemia, Colitis, Death, Diabetes/Incr. blood sugar, Hypercholesterolemia, Hyperlipidemia, Increased serum creatinine, Infections (Frequent), Infusion/drug reactions, Lupus-like reaction, Lymphoma, Malignancy, Multiple Sclerosis, Neutropenia, Palliative care, Renal disease, Sarcoid, Thrombocytopenia, and Uveitis.

In addition, the treatment result data of the patient population may also include information regarding additional reasons for discontinuation for the physician's review and consideration. Example discontinuation reasons include: Changed Mode/Dosage, Ineffective, Patient preference, Effective, Loss of Efficacy, Contraindication, Cost, Insurance preference, Surgery, and Pregnant.

At an act A110, in one embodiment, the treatment options are ordered and enumerated according to the comparative effectiveness results having the highest count of adverse events in the population of patients to the lowest counts of adverse events.

At an act A112, each treatment option is selected one by one.

At an act A114, the score to be added to the respective treatment option counter is the enumeration value. Thus, the treatment options with the fewer adverse events are awarded more points.

At an act A116, the counters for any remaining treatment options are adjusted at additional executions of act A114.

At an act A118, the loop L26 and method of FIG. 11 terminate if no additional disease activity metrics remain to be analyzed.

APPENDIX A

| Patient Characteristic | Data Type | Sample Patient Matching Heuristic |
|---|---|---|
| Order of medications | Boolean | |
| (e.g. “firstline?”) | | |
| Inflammation | Boolean | |
| Individual PQRS | Boolean | |
| measures | | |
| RF positive | Boolean | |
| ACPA positive (CCP) | Boolean | |
| Erosions | Boolean | |
| For at least six weeks, | Boolean | |
| joint stiffness has lasted | | |
| >=1 hour before max | | |
| improvement | | |
| Cardiac | Boolean | |
| Pericarditis | Boolean | |
| CAD, CVD, or CHF | Boolean | |
| Hyperlipidemia | Boolean | |
| Hypertension | Boolean | |
| ILD - CXR, CT, or PFT | Boolean | |
| Rheumatoid Nodules | Boolean | |
| Ocular | Boolean | |
| Scleritis | Boolean | |
| Uveitis | Boolean | |
| Sjogrens - symptoms + | Boolean | |
| SSA, SSB, Schirmer's or | | |
| optho/optometry opinion | | |
| Vasculitis | Boolean | |
| Diabetes | Boolean | |
| Osteoporosis | Boolean | |
| Periodontal disease | Boolean | |
| Smoking | Boolean | |
| Deformity | Boolean | |
| Disability - applying for or | Boolean | |
| on government disability | | |
| Joint Replacement | Boolean | |
| Hepatitis B | Boolean | |
| Hepatitis C | Boolean | |
| Lymphoma | Boolean | |
| TB positive | Boolean | |
| HLAB27 positive | Boolean | |
| Sacroilitis - imaging | Boolean | |
| Syndesmophytes - | Boolean | |
| imaging | | |
| Enthesitis - provider | Boolean | |
| witnessed, Achilles or | | |
| recurrent plantar | | |
| Dactylitis - provider | Boolean | |
| witnessed | | |
| Psoriasis - provider | Boolean | |
| witnessed | | |
| Nail dystrophy - provider | Boolean | |
| witnessed | | |
| Colitis - colonoscopy | Boolean | |
| assessment | | |
| Urethritis - provider | Boolean | |
| witnessed | | |
| Oral sores - provider | Boolean | |
| witnessed | | |
| Iritis - ophto/optometry dx | Boolean | |
| Hip replacement | Boolean | |
| Disability - apply for or on | Boolean | |
| government disability | | |
| CAD - MI, angiogram | Boolean | |
| diagnosed, stress test c/w | | |
| with CAD | | |
| DoB/Age | DateTime/ | The Freedman-Diaconis rule for |
| | Continuous | estimating bin sizes. |
| Tender Joint Count | Continuous | The Freedman-Diaconis rule for |
| | | estimating bin sizes. |
| Swollen Joint Count | Continuous | The Freedman-Diaconis rule for |
| | | estimating bin sizes. |
| Tender Joint Location | Nominal | |
| Swollen Joint Location | Nominal | |
| Lab results | Continuous | Lab results may be converted to nominal |
| | | values of low-normal, high-normal, low > |
| | | ULN, or high > ULN |
| MD and Pt Global, | Continuous | The Freedman-Diaconis rule for |
| Disease, and pain scores | | estimating bin sizes. |
| DAMs (Disease activity | Continuous | Bins are predefined according to |
| Metrics) | | remission, low, moderate, and high states |
| The Individual SpA | Continuous | The Freedman-Diaconis rule for |
| Measurements | | estimating bin sizes. |
| Pre-assessment score | Continuous | The Freedman-Diaconis rule for |
| | | estimating bin sizes. |
| Zip Code or postal code | Nominal | |
| Med dosage | Continuous | |
| | or nominal | |
| Diagnosis | Nominal | |
| Gender | Nominal | |
| Race | Nominal | |
| Ethnicity | Nominal | |
| Language | Nominal | |
| Education | Nominal | |
| Expired | Nominal | |
| Having JointEval | Nominal | |
| DAM state | Nominal | |
| Pre-assessment result | Nominal | |
| Disc reason | Nominal | |
| 1987 criteria | Nominal | |
| First diagnosis date | Date/time | |
| Epigenetics profiles | Nominal | |

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended aspects appropriately interpreted in accordance with the doctrine of equivalents.

Further, aspects herein have been presented for guidance in construction and/or operation of illustrative embodiments of the disclosure. Applicant(s) hereof consider these described illustrative embodiments to also include, disclose and describe further inventive aspects in addition to those explicitly disclosed. For example, the additional inventive aspects may include less, more and/or alternative features than those described in the illustrative embodiments. In more specific examples, Applicants consider the disclosure to include, disclose and describe methods which include less, more and/or alternative steps than those methods explicitly disclosed as well as apparatus which includes less, more and/or alternative structure than the explicitly disclosed structure.

What is claimed is:

1. A medical treatment method comprising:
obtaining data values for a plurality of patient characteristics of a subject patient to be treated for a medical condition;
using the data values of the patient characteristics of the subject patient, searching treatment results of a plurality previous patients which were treated for the medical condition using a plurality of different treatment options; and
using the searching, providing information to medical personnel regarding the treatment results of the previous patients which were treated for the medical condition for each of the treatment options, the information being usable to assist the medical personnel with treatment of the subject patient for the medical condition.

2. The method of claim 1 further comprising selecting different ones of the patient characteristics for different ones of the treatment options to be used in the searching of the treatment results.

3. The method of claim 2 wherein the selecting comprises:
processing the treatment results for the different treatment options; and
identifying the different ones of the patient characteristics for the treatment options using the processing.

4. The method of claim 2 wherein the selected different ones of the patient characteristics have an increased correspondence to the treatment of the medical condition using the respective treatment options compared with others of the patient characteristics.

5. The method of claim 1 wherein the searching comprises searching the treatment results for the different treatment options using the data values of different ones of the patient characteristics.

6. The method of claim 5 further comprising, for each of the treatment options, identifying a population of the previous patients having data values for the patient characteristics for the respective treatment option which correspond to the data values for the patient characteristics for the respective treatment option of the subject patient.

7. The method of claim 6 wherein the providing information comprises, for each of the treatment options, providing information using only the treatment results for the identified population of the previous patients for the respective treatment option.

8. The method of claim 1 wherein the providing comprises providing information indicating that one of the treatment options has increased effectiveness to treat the medical condition compared with another of the treatment options.

9. The method of claim 1 wherein the providing comprises providing information indicating that one of the treatment options has increased safety to treat the medical condition compared with another of the treatment options.

10. The method of claim 1 further comprising:
after the providing, altering one of the patient characteristics; and
providing different information regarding the treatment results of the previous patients for the medical condition as a result of the altering the one of the patient characteristics.

11. A computer system configured to perform the method of claim 1.

12. A medical treatment method comprising:
identifying a plurality of possible treatment options which may be used to treat a medical condition of a subject patient;
for each of the treatment options, processing treatment results regarding treatment of a plurality of previous patients using the respective treatment option; and
using the processing, and for each of the treatment options, identifying at least one patient characteristic which is indicative of treatment of the previous patients using the respective treatment option and which may be used to assist determination of a medicine for treatment of a subject patient having the medical condition.

13. The method of claim 12 wherein the identifying comprises, for each of the treatment options, identifying the at least one patient characteristic which is indicative of effectiveness of the respective treatment option to treat the previous patients.

14. The method of claim 12 wherein the identifying comprises, for each of the treatment options, identifying the at least one patient characteristic which is indicative of safety of the respective treatment option to treat the previous patients.

15. The method of claim 12 further comprising receiving additional treatment results regarding treatment of the previous patients using the treatment options after the identifying, and wherein the processing further comprises processing the additional treatment results, and further comprising, for at least one of the treatment options, updating the identified at least one patient characteristic as a result of the processing the additional treatment results.

16. The method of claim 15 wherein the updating comprises replacing the identified at least one patient characteristic with another patient characteristic.

17. The method of claim 12 further comprising accessing, for each of the treatment options, a plurality of requests for the identified at least one patient characteristic for the respective treatment option, and outputting the identified at least one patient characteristic for each of the treatment options as a result of accessing the requests.

18. The method of claim 12 further comprising:
accessing a plurality of patient characteristics for a subject patient;
for one of the treatment options, processing a data value of at least one of the patient characteristics of the subject patient which corresponds to the identified at least one patient characteristic for the one treatment option; and
identifying a population of the previous patients which correspond to the subject patient as a result of the processing the data.

19. The method of claim 18 further comprising outputting the treatment results of the identified population of the previous patients for the one of the treatment options.

20. The method of claim 12 wherein each of the treatment options comprises at least one medication.

21. A computer system configured to perform the method of claim 12.
